(19) United States
(12) Patent Application Publication
(10) Pub. No.: US 2009/0228734 A1
(43) Pub. Date: Sep. 10, 2009

(54) Electronic device and system start method

(75) Inventor: Michito Kakie, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/289,468

(22) Filed: Oct. 28, 2008

(30) Foreign Application Priority Data
Mar. 6, 2008 (JP) 2008-056948

(51) Int. Cl. G06F 1/08

(52) U.S. Cl. 713/501

(57) ABSTRACT

An electronic device and a system start method that reduce electric power consumption and improves convenience. A state check section detects that an information processing section is being booted and that a telephone conversation is being carried out by the use of an information processing section (portable telephone). When the state check section detects this state, the state check section outputs instructions to a clock control section to lower a frequency of an operation clock of a processing circuit included in the information processing section. When the clock control section accepts the instructions from the state check section to lower the frequency of the operation clock of the processing circuit, the clock control section lowers the frequency of the operation clock of the processing circuit.

### CROSS-REFERENCE TO RELATED APPLICATIONS

This application is based upon and claims the benefits of priority from the prior Japanese Patent Application No. 2008-056948, filed on Mar. 6, 2008, the entire contents of which are incorporated herein by reference.

### BACKGROUND OF THE INVENTION

(1) Field of the Invention

This invention relates to an electronic device and a system start method, and more particularly, to an electronic device in which a system start is controlled and a system start method for controlling a system start.

(2) Description of the Related Art

Usually the portable device which is a kind of electronic device is powered by a battery for the purpose of miniaturization and lightening. In addition, electric power obtained by a small battery used in a portable device is low. Accordingly, in order to lengthen time for which a portable device operates, it is necessary to efficiently use electric power stored in a battery.

With a portable device having a telephone function or a radio communication function in particular, electric power consumption is high at telephone conversation time or radio communication time. If the electric power the portable device cannot be maintained because of a drop in voltage caused by the internal resistance of a battery. If high electric power is supplied with a lack of electric power at the time of a drop in voltage taken into consideration, then the duration of the battery becomes short. That is to say, in order to maintain the operating state of the portable device for a long period of time, it is necessary to suppress maximum electric power consumption.

A method for suppressing the maximum electric power consumption of a portable device having a radio communication function by inhibiting sending operation corresponding to the receiving of radio communication during a period of time for which the other system is consuming high electric power by performing a process is known as a method for solving these problems (see, for example, Japanese Patent Laid-Open Publication No. 2001-111655). Furthermore, a method for reducing the maximum electric power consumption of a portable device which can be used for imaging and carrying out a radiotelephone conversation by stopping or restricting, at the time of receiving a radiotelephone call during imaging, an imaging function and having a radiotelephone conversation is known (see, for example, Japanese Patent Laid-Open Publication No. 2004-166005 or No. 2005-156741).

Usually a central processing unit (CPU) which is a processing circuit included in an electronic device realizes the saving of electric power under conditions of a light load by lowering an operation clock frequency. Under conditions of a heavy load, the CPU demonstrates maximum performance. That is to say, the CPU operates at a maximum clock frequency. At this time the CPU consumes electric power the most. The electronic device includes a plurality of electronic circuits. When the plurality of electronic circuits operate at the same time, the load on the CPU increases. Accordingly, the CPU consumes comparatively high electric power to perform each process.

With the method disclosed in the above Japanese Patent Laid-Open Publication No. 2001-111655, radio communication is limited and another process is preferentially performed. By doing so, the processing load on an electronic device decreases and the electric power consumption of the electronic device is reduced. However, the usability of both functions is reduced. This is inconvenient.

### SUMMARY OF THE INVENTION

The present invention was made under the background circumstances described above. An object of the present invention is to provide a very convenient device and system start method which can reduce electric power consumption.

In order to achieve the above object, an electronic device powered by a battery is provided. This electronic device comprises a first information processing section, a second information processing section operable in parallel with the first information processing section for realizing a portable telephone function, a state check section for outputting instructions to lower a frequency of an operation clock of a processing circuit included in the first information processing section at the time of detecting that the first information processing section is being booted and that a telephone conversation is being carried out by the use of the second information processing section, and a clock control section for lowering the frequency of the operation clock of the processing circuit at the time of accepting the instructions outputted from the state check section to lower the frequency of the operation clock of the processing circuit.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic view showing an electronic device according to the present invention.

FIG. 2 is a view showing the hardware configuration of a portable device according to the embodiment of the present invention.

FIG. 3 is a block diagram showing the functions of the portable device.

FIG. 4 is a view showing an example of the data structure of a system state table.

FIG. 5 is a flow chart showing a clock control process.

FIG. 6 is a flow chart showing a clock control process performed in the case where a telephone conversation by the use of a portable telephone section is begun.

FIG. 7 is a sequence diagram showing a first concrete example of the flow of a clock control process.

FIG. 8 is a sequence diagram showing a second concrete example of the flow of a clock control process.

### DESCRIPTION OF THE PREFERRED EMBODIMENTS

An embodiment of the present invention will now be described in detail with reference to the drawings. An overview of an embodiment of the present invention will be given first. Then the concrete contents of the embodiment of the present invention will be described.

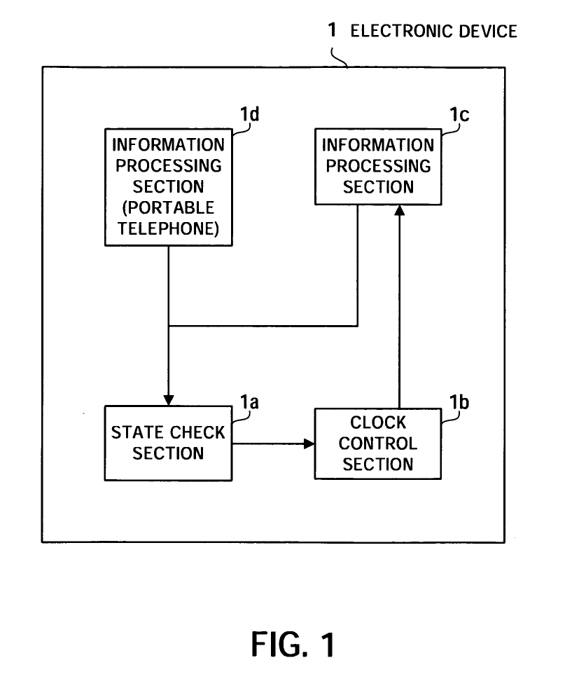

FIG. 1 is a schematic view showing an electronic device according to the present invention. An electronic device 1 shown in FIG. 1 can realize the function of an information processing section 1c and the function of an information processing section 1d having a portable telephone function in parallel. The electronic device 1 includes a set of hardware resources required to realize the function of the information processing section 1c and a set of hardware resources required to realize the function of the information processing section 1d having a portable telephone function. These sets of hardware resources can operate as independent information processing sections. In this case, a set of hardware resources means a group of hardware, such as a CPU or a random access memory (RAM), required to form a single system. The information processing sections 1c and 1d execute individual operating systems (OSes). The function of the information processing section 1c and the function of the information processing section 1d having a portable telephone function are realized by the electronic device 1. Each CPU is an example of a processing circuit.

The electronic device 1 includes a state check section 1a and a clock control section 1b.

When the state check section 1a detects that the information processing section 1c is being booted and that a telephone conversation is being carried out by the use of the information processing section 1d, the state check section 1a outputs instructions to lower the frequency of an operation clock of the CPU included in the information processing section 1c.

By, for example, accepting notice of a boot start from the information processing section 1c, the state check section 1a can check whether the information processing section 1c is being booted.

In addition, by, for example, accepting notice of a telephone conversation start from the information processing section 1d, the state check section 1a can check whether a telephone conversation is being carried out by the use of the information processing section 1d. Furthermore, the following method may be used. The state check section 1a sends the information processing section 1d a confirmation request in order to check the state of the information processing section 1d. On the basis of a response to the confirmation request, the state check section 1a checks whether a telephone conversation is being carried out by the use of the information processing section 1d.

When the clock control section 1b accepts the instructions outputted from the state check section 1a to lower the frequency of the operation clock of the CPU included in the information processing section 1c, the clock control section 1b lowers the frequency of the operation clock of the CPU included in the information processing section 1c. The extent to which the clock control section 1b lowers the frequency of the operation clock is set in advance in a storage area of the clock control section 1b.

The following effect can be obtained by the electronic device 1 having the above structure. For example, even if the information processing section 1c is being booted at the time of a telephone conversation being begun by the use of the information processing section 1d, the electric power consumption of the information processing section 1c can be reduced by lowering the frequency of the operation clock of the CPU which performs a boot process in the information processing section 1c. Accordingly, the electric power consumption of the entire electronic device 1 can be reduced. This avoids the discontinuance of a telephone conversation caused by the inability to maintain the operation of the information processing sections 1c and 1d. For example, when there is a sharp drop in the voltage of a power source of the electronic device 1, the operation of the information processing sections 1c and 1d cannot be maintained. Furthermore, there is no need to inhibit a telephone conversation realized by the use of the information processing section 1d having a portable telephone function while the information processing section 1c is being booted. This is convenient. In addition, an electric power load on the power source can be reduced. Accordingly, if a battery, for example, is used as the power source, its duration can be lengthened.

If the frequency of the operation clock of the CPU included in the information processing section 1c remains low, then the information processing section 1c cannot demonstrate its performance fully. Therefore, when the process of booting the information processing section 1c is completed or when a telephone conversation by the use of the information processing section 1d is completed, the frequency of the operation clock of the CPU included in the information processing section 1c may automatically be returned to the original frequency.

The above electronic device will now be described more concretely with reference to the drawings.

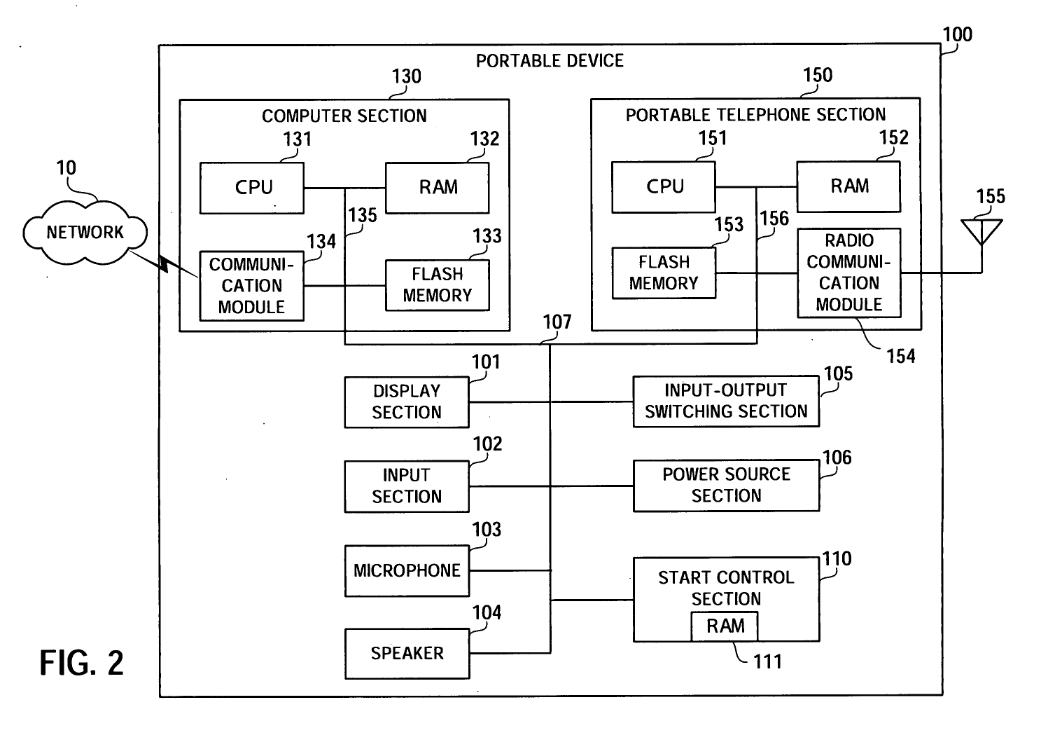

FIG. 2 is a view showing the hardware configuration of a portable device according to the embodiment of the present invention. A portable device 100 includes a computer section 130 and a portable telephone section 150 and can make these two information processing sections operate in parallel. Sections of the portable device 100 are connected to one another via a bus 107.

A display section 101 is a monitor on which an image is displayed in accordance with an instruction issued by a CPU of each section. A liquid crystal monitor, for example, is used as the display section 101.

An input section 102 provides input to the computer section 130 or the portable telephone section 150. A keyboard, a pointing device, or the like is used as the input section 102.

A microphone 103 provides audio input to the computer section 130 or provides audio input at telephone conversation time to the portable telephone section 150.

Audio output from the computer section 130 or audio output from the portable telephone section 150 at telephone conversation time is provided to a speaker 104.

An input-output switching section 105 switches the object of operation between the computer section 130 and the portable telephone section 150. A source from which output is provided to the display section 101 or the speaker 104 can be switched by the input-output switching section 105. Similarly, a destination to which input is provided from the input section 102 or the microphone 103 can be switched. A user operates, for example, a changeover switch (not shown) on the portable device 100. By doing so, the user can give the input-output switching section 105 instructions to perform switching operation.

A power source section 106 is connected to a battery (not shown) and supplies electric power to each section of the portable device 100.

A start control section 110 monitors the operating state of the computer section 130 and the portable telephone section 150. In addition, the start control section 110 controls the frequency of a clock of the CPU when the computer section 130 is being booted. The start control section 110 includes a RAM 111. The RAM 111 stores data required for a process performed by the start control section 110.

The hardware configuration of the computer section 130 will now be described.

The whole of the computer section 130 is controlled by a CPU 131. A RAM 132, a flash memory 133, and a communication module 134 are connected to the CPU 131 via a bus 135.

The RAM 132 temporarily stores at least part of an OS or an application program (hereafter application) executed by the CPU 131. The RAM 132 also stores various pieces of data required for a process performed by the CPU 131.

The flash memory 133 stores the OS or the application program on the computer section 130. The flash memory 133 also stores the various pieces of data required for a process performed by the CPU 131.

The communication module 134 sends data to or receives data from another computer via a network 10.

The hardware configuration of the portable telephone section 150 will now be described.

The whole of the portable telephone section 150 is controlled by a CPU 151. A RAM 152, a flash memory 153, and a radio communication module 154 are connected to the CPU 151 via a bus 156. In addition, an antenna 155 is connected to the radio communication module 154.

The RAM 152 temporarily stores at least part of an OS or an application program executed by the CPU 151. The RAM 152 also stores various pieces of data required for a process performed by the CPU 151.

The flash memory 153 stores the OS or the application program on the portable telephone section 150. The flash memory 153 also stores the various pieces of data required for a process performed by the CPU 151.

The radio communication module 154 includes a radio frequency (RF) circuit for radio communication, a circuit for modulating and demodulating signals sent and received, and the like. The portable telephone section 150 performs radio communication with a base station via the radio communication module 154 and the antenna 155. By doing so, the portable telephone section 150 can send data to or receive data from another information processing device and hold a telephone conversation with another information processing device. In this case, an information processing device is, for example, a portable telephone.

By adopting the above hardware configuration, the functions of the portable device according to the embodiment of the present invention can be realized.

The functions of the portable device 100 will now be described.

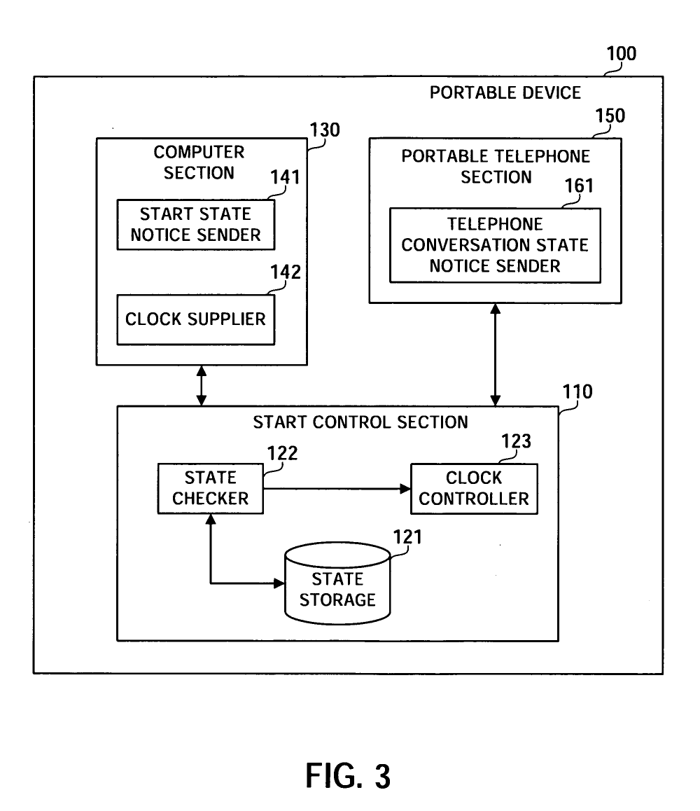

FIG. 3 is a block diagram showing the functions of the portable device. The portable device 100 includes the start control section 110, the computer section 130, and the portable telephone section 150.

The start control section 110 includes a state storage 121, a state checker 122, and a clock controller 123.

The state storage 121 stores a system state table in which information indicative of whether the computer section 130 is being booted and whether a telephone conversation is being carried out by the use of the portable telephone section 150 is included.

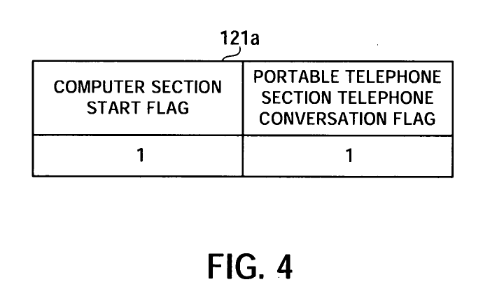

The state checker 122 accepts notice of a boot start and notice of a boot end sent from a start state notice sender 141 of the computer section 130. In addition, the state checker 122 accepts notice of a telephone conversation start and notice of a telephone conversation end sent from a telephone conversation state notice sender 161 of the portable telephone section 150. When the state checker 122 accepts the above notice, the state checker 122 updates the system state table stored in the state storage 121 on the basis of information the state checker 122 accepts. Then the state checker 122 refers to the above system state table. If the state checker 122 detects that the computer section 130 is being booted and that a telephone conversation is being carried out by the use of the portable telephone section 150, then the state checker 122 outputs instructions to lower the frequency of an operation clock of the CPU 131 of the computer section 130. The system state table will be described in detail in FIG. 4.

Furthermore, when the state checker 122 detects at the least one of the end of booting the computer section 130 and the end of the telephone conversation by the use of the portable telephone section 150 after detecting that the computer section 130 is being booted and that the telephone conversation is being carried out by the use of the portable telephone section 150, the state checker 122 outputs instructions to return the frequency of the operation clock of the CPU 131 of the computer section 130.

When the clock controller 123 accepts the instructions outputted from the state checker 122 to lower the frequency of the operation clock of the CPU 131 of the computer section 130, the clock controller 123 controls a clock supplier 142 of the computer section 130 to lower the frequency of the operation clock of the CPU 131. In addition, when the clock controller 123 accepts the instructions outputted from the state checker 122 to return the frequency of the operation clock of the CPU 131, the clock controller 123 controls the clock supplier 142 of the computer section 130 to return the frequency of the operation clock of the CPU 131 to the original frequency.

The computer section 130 includes the start state notice sender 141 and the clock supplier 142.

When the computer section 130 shifts from a power off state to a state in which the computer section 130 is being booted, the start state notice sender 141 outputs notice of a boot start to the state checker 122. When the booting of the computer section 130 ends, the start state notice sender 141 outputs notice of a boot end to the state checker 122.

The clock supplier 142 supplies a clock necessary for the operation of the CPU 131. The clock supplier 142 is controlled by the clock controller 123 to increase or decrease the frequency of the clock supplied. The clock supplier 142 is included in, for example, the CPU 131 and converts the frequency of a clock supplied from a phase locked loop (PLL), which is not shown in FIG. 2, included in the computer section 130 into a frequency suitable for the operation of the CPU 131.

The portable telephone section 150 includes the telephone conversation state notice sender 161. When a state in which a telephone conversation is not being carried out by the use of the portable telephone section 150 shifts to a state in which a telephone conversation is being carried out by the use of the portable telephone section 150, the telephone conversation state notice sender 161 outputs notice of a telephone conversation start to the state checker 122. When the telephone conversation by the use of the portable telephone section 150 ends, the telephone conversation state notice sender 161 outputs notice of a telephone conversation end to the state checker 122.

The system state table stored in the state storage 121 will now be described.

FIG. 4 is a view showing an example of the data structure of a system state table. A system state table 121a includes items indicative of a computer section start flag and a portable telephone section telephone conversation flag.

A flag indicative of whether the computer section 130 is being booted is set under the Computer Section Start Flag item. For example, if the computer section 130 is being booted, then “1” is set under the Computer Section Start Flag item. If the computer section 130 is not being booted, then “0” is set under the Computer Section Start Flag item. A flag indicative of whether a telephone conversation is being carried out by the use of the portable telephone section 150 is set under the Portable Telephone Section Telephone Conversation Flag item. For example, if a telephone conversation is being carried out by the use of the portable telephone section 150, then “1” is set under the Portable Telephone Section Telephone Conversation Flag item. If a telephone conversation is not being carried out by the use of the portable telephone section 150, then “0” is set under the Portable Telephone Section Telephone Conversation Flag item.

In the system state table 121a, for example, “1” is set under the Computer Section Start Flag item and “1” is set under the Portable Telephone Section Telephone Conversation Flag item. This indicates that the computer section 130 is being booted and that a telephone conversation is being carried out by the use of the portable telephone section 150. When the state checker 122 detects this state of the system state table 121a, the state checker 122 outputs instructions to the clock controller 123 to lower a clock frequency.

In addition, it is assumed that after “1” is set under the Computer Section Start Flag item and the Portable Telephone Section Telephone Conversation Flag item included in the system state table 121a, the telephone conversation by the use of the portable telephone section 150 ends. At this time the state checker 122 changes “1” set under the Portable Telephone Section Telephone Conversation Flag item included in the system state table 121a to “0”. Then the state checker 122 detects that the state in which both of the above flags (that is to say, the computer section start flag and the portable telephone section telephone conversation flag) are “1” (“1, 1”) has shifted to a state in which at the least one of these flags is “0” (“1, 0”). After the state in which the computer section 130 is being booted and in which a telephone conversation is being carried out by the use of the portable telephone section 150 has arisen, the booting of the computer section 130 ends or the telephone conversation by the use of the portable telephone section 150 ends. By using the above system state table, the state checker 122 can output instructions to return the frequency of the operation clock of the CPU 131 included in the computer section 130, when the state checker 122 detects at the least one of the end of the booting of the computer section 130 and the end of the telephone conversation by the use of the portable telephone section 150.

A process performed by adopting the above structure and data structure will now be described in detail.

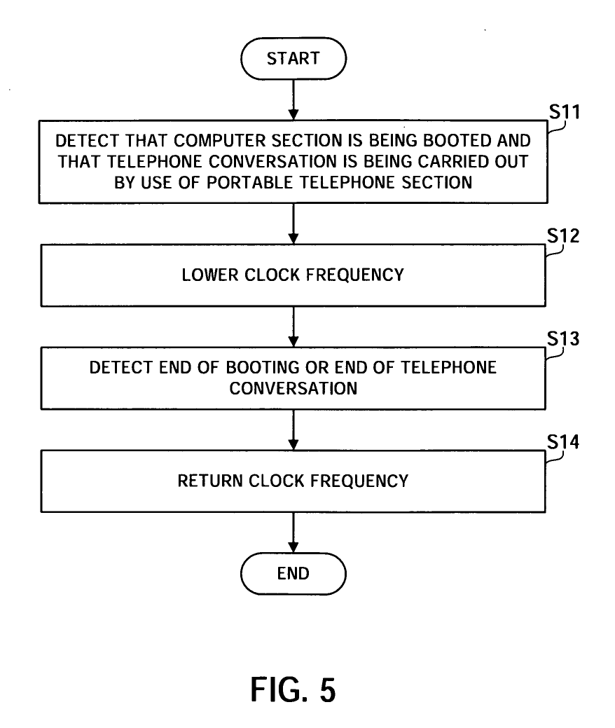

FIG. 5 is a flow chart showing a clock control process. A process shown in FIG. 5 will now be described in order of step number.

[Step S11] The state checker 122 refers to the system state table 121a. When the state checker 122 detects that the computer section 130 is being booted and that a telephone conversation is being carried out by the use of the portable telephone section 150, the state checker 122 outputs instructions to the clock controller 123 to lower the frequency of the operation clock of the CPU 131.

[Step S12] When the clock controller 123 accepts the instructions outputted from the state checker 122 to lower the frequency of the operation clock of the CPU 131, the clock controller 123 controls the clock supplier 142 of the computer section 130 to lower the frequency of the operation clock of the CPU 131.

[Step S13] The state checker 122 refers to the system state table 121a. When the state checker 122 detects at the least one of the end of the booting of the computer section 130 and the end of the telephone conversation by the use of the portable telephone section 150, the state checker 122 outputs instructions to the clock controller 123 to return the frequency of the operation clock of the CPU 131.

[Step S14] When the clock controller 123 accepts the instructions outputted from the state checker 122 to return the frequency of the operation clock of the CPU 131, the clock controller 123 controls the clock supplier 142 of the computer section 130 to return the frequency of the operation clock of the CPU 131 to the original frequency.

A significant increase in the electric power consumption of the portable device 100 which is caused while the computer section 130 is being booted and while a telephone conversation is being carried out by the use of the portable telephone section 150 can be avoided in this way.

The flow of a process performed in the case where a telephone conversation by the use of the portable telephone section 150 is begun will now be described in detail as an example of the process of controlling the operation clock of the CPU 131 included in the computer section 130.

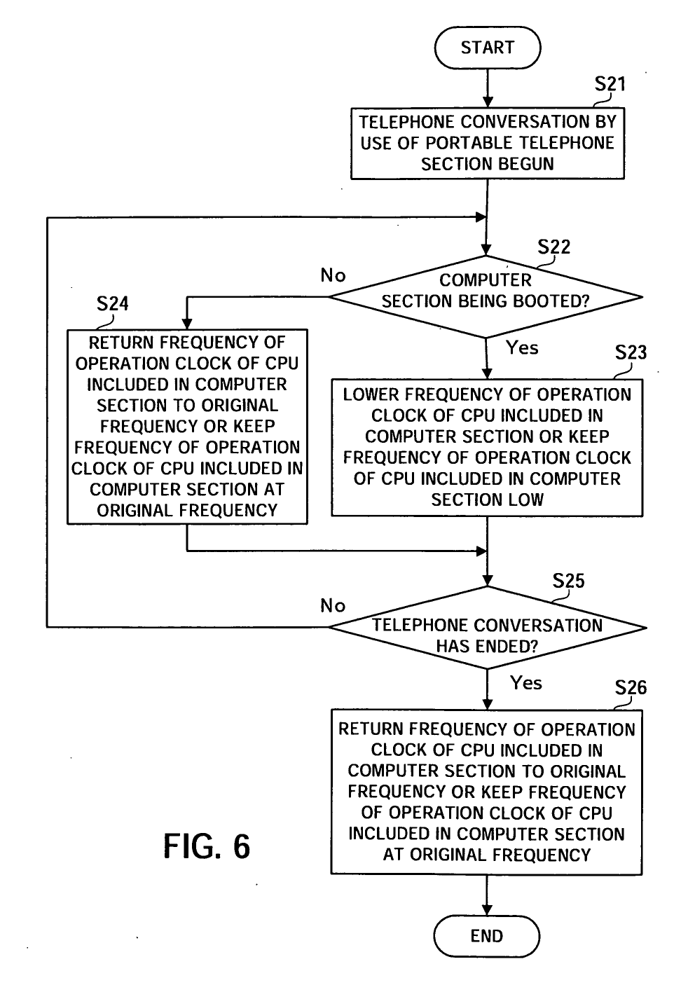

FIG. 6 is a flow chart showing a clock control process performed in the case where a telephone conversation by the use of a portable telephone section is begun. A process shown in FIG. 6 will now be described in order of step number.

[Step S21] Telephone conversation by the use of the portable telephone section 150 is begun. For example, a telephone conversation by the use of the portable telephone section 150 is begun according to input operation performed by a user to make a call. In addition, there are cases where a telephone conversation by the use of the portable telephone section 150 is begun with a caller according to input operation performed by a user in response to a telephone call received. The state checker 122 detects that a telephone conversation is being carried out by the use of the portable telephone section 150.

[Step S22] The state checker 122 detects whether the computer section 130 is being booted. If the computer section 130 is being booted (that is to say, a boot is begun just before a telephone conversation is begun), then step S23 is performed. If the computer section 130 is not being booted (in this example, the computer section 130 is in a normal operating state after a boot), then step S24 is performed. Basically the computer section 130 is booted according to input operation performed by the user. However, the boot of the computer section 130 may automatically be begun, for example, at a specific time.

[Step S23] The state checker 122 outputs instructions to the clock controller 123 to lower the frequency of the operation clock of the CPU 131. When the clock controller 123 accepts the instructions outputted from the state checker 122 to lower the frequency of the operation clock of the CPU 131, the clock controller 123 controls the clock supplier 142 of the computer section 130 to lower the frequency of the operation clock of the CPU 131. If the frequency of the operation clock of the CPU 131 has already been lowered, then this state is maintained.

[Step S24] The state checker 122 outputs instructions to the clock controller 123 to return the frequency of the operation clock of the CPU 131. When the clock controller 123 accepts the instructions outputted from the state checker 122 to return the frequency of the operation clock of the CPU 131, the clock controller 123 controls the clock supplier 142 of the computer section 130 to return the frequency of the operation clock of the CPU 131 to the original frequency. If the frequency of the operation clock of the CPU 131 has already been returned to the original frequency, then this state is maintained.

[Step S25] The state checker 122 detects whether the telephone conversation by the use of the portable telephone section 150 has ended. If the telephone conversation by the use of the portable telephone section 150 has ended, then step S26 is performed. If the telephone conversation by the use of the portable telephone section 150 has not ended, then step S22 is performed.

[Step S26] The state checker 122 outputs instructions to the clock controller 123 to return the frequency of the operation clock of the CPU 131. When the clock controller 123 accepts the instructions outputted from the state checker 122 to return the frequency of the operation clock of the CPU 131, the clock controller 123 controls the clock supplier 142 of the computer section 130 to return the frequency of the operation clock of the CPU 131 to the original frequency. If the frequency of the operation clock of the CPU 131 has already been returned to the original frequency, then this state is maintained.

The state checker 122 may check the state of the computer section 130 and the portable telephone section 150 at timing at which the state checker 122 accepts notice from each section or at regular time intervals.

The case where a telephone conversation by the use of the portable telephone section 150 is begun while the computer section 130 is being booted or the case where the booting of the computer section 130 is begun while a telephone conversation by the use of the portable telephone section 150 is being carried out can be cited as an example of the case where the frequency of the operation clock of the CPU 131 included in the computer section 130 is controlled. The concrete flow of communication performed in these cases between the start control section 110, the computer section 130, and the portable telephone section 150 will now be described.

The case where a telephone conversation by the use of the portable telephone section 150 is begun while the computer section 130 is being booted will be described first.

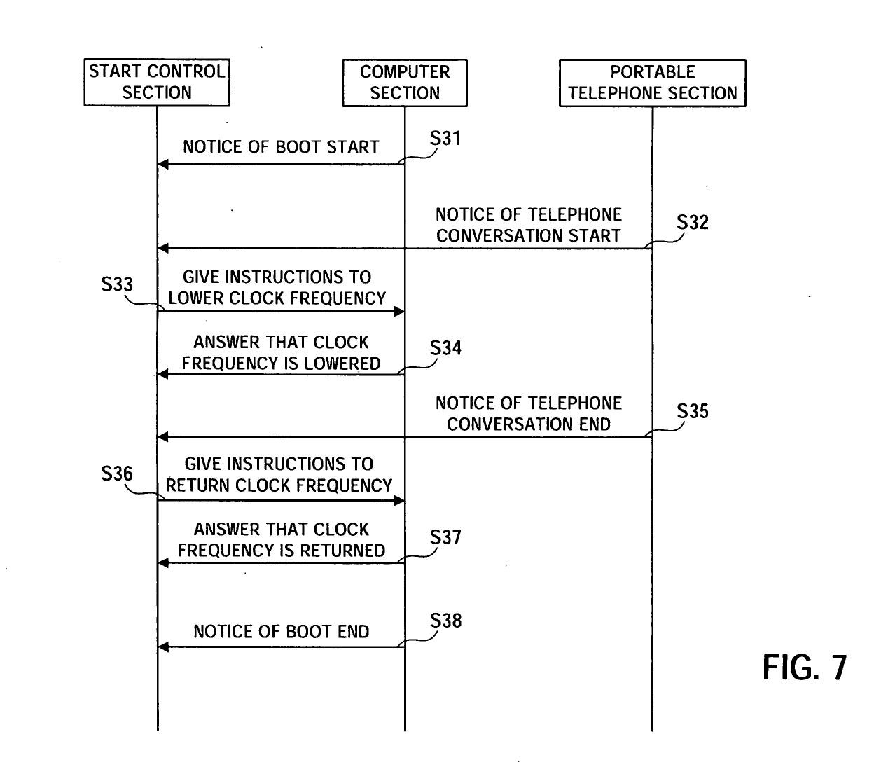

FIG. 7 is a sequence diagram showing a first concrete example of the flow of a clock control process. A process shown in FIG. 7 will now be described in order of step number.

[Step S31] When the booting of the computer section 130 is begun, the computer section 130 outputs notice of a boot start to the start control section 110.

[Step S32] When a telephone conversation by the use of the portable telephone section 150 is begun, the portable telephone section 150 outputs notice of a telephone conversation start to the start control section 110.

[Step S33] The start control section 110 gives the computer section 130 instructions to lower the frequency of the operation clock of the CPU 131.

[Step S34] The computer section 130 answers the start control section 110 that the frequency of the operation clock of the CPU 131 is lowered.

[Step S35] When the telephone conversation by the use of the portable telephone section 150 ends, the portable telephone section 150 outputs notice of a telephone conversation end to the start control section 110.

[Step S36] The start control section 110 gives the computer section 130 instructions to return the frequency of the operation clock of the CPU 131 to the original frequency.

[Step S37] The computer section 130 answers the start control section 110 that the frequency of the operation clock of the CPU 131 is returned to the original frequency.

[Step S38] When the booting of the computer section 130 ends, the computer section 130 outputs notice of a boot end to the start control section 110.

The order of the above steps S35 and S38 may reverse. That is to say, when at the least one of the booting of the computer section 130 and the telephone conversation by the use of the portable telephone section 150 ends, the frequency of the operation clock of the CPU 131 included in the computer section 130 is returned to the original frequency.

The case where the booting of the computer section 130 is begun while a telephone conversation by the use of the portable telephone section 150 is being carried out will be described next.

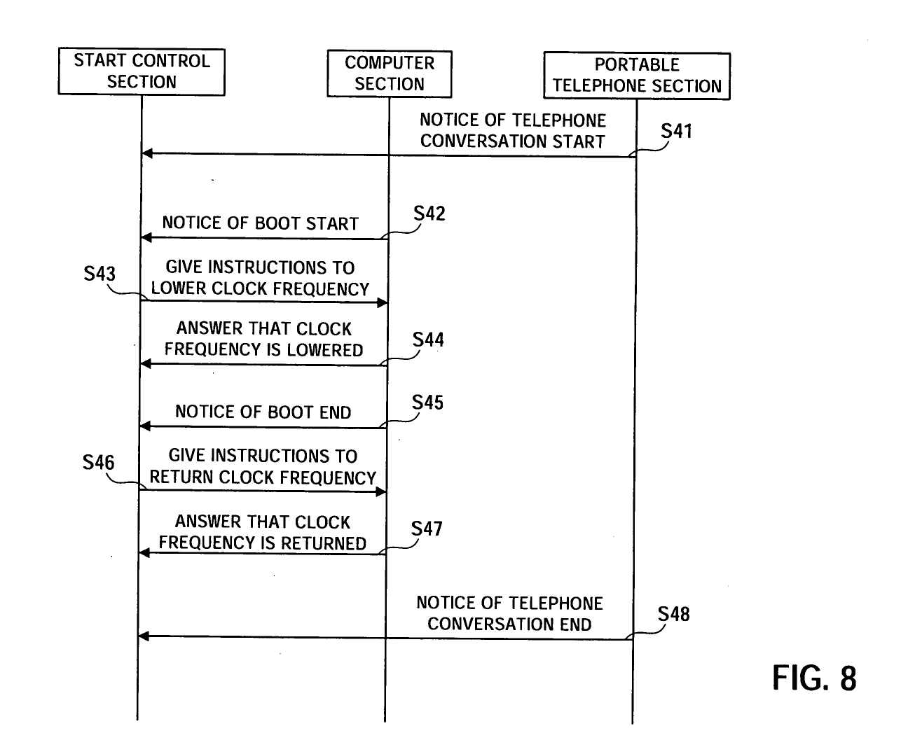

FIG. 8 is a sequence diagram showing a second concrete example of the flow of a clock control process. A process shown in FIG. 8 will now be described in order of step number.

[Step S41] When a telephone conversation by the use of the portable telephone section 150 is begun, the portable telephone section 150 outputs notice of a telephone conversation start to the start control section 110.

[Step S42] When the booting of the computer section 130 is begun, the computer section 130 outputs notice of a boot start to the start control section 110.

[Step S43] The start control section 110 gives the computer section 130 instructions to lower the frequency of the operation clock of the CPU 131.

[Step S44] The computer section 130 answers the start control section 110 that the frequency of the operation clock of the CPU 131 is lowered.

[Step S45] When the booting of the computer section 130 ends, the computer section 130 outputs notice of a boot end to the start control section 110.

[Step S46] The start control section 110 gives the computer section 130 instructions to return the frequency of the operation clock of the CPU 131 to the original frequency.

[Step S47] The computer section 130 answers the start control section 110 that the frequency of the operation clock of the CPU 131 is returned to the original frequency.

[Step S48] When the telephone conversation by the use of the portable telephone section 150 ends, the portable telephone section 150 outputs notice of a telephone conversation end to the start control section 110.

The order of the above steps S45 and S48 may reverse. That is to say, when at the least one of the booting of the computer section 130 and the telephone conversation by the use of the portable telephone section 150 ends, the frequency of the operation clock of the CPU 131 included in the computer section 130 is returned to the original frequency.

A significant increase in the electric power consumption of the portable device 100 which is caused while the computer section 130 is being booted and while a telephone conversation is being carried out by the use of the portable telephone section 150 can be avoided in this way. In addition, a telephone conversation by the use of the portable telephone section 150 can be carried out preferentially.

This avoids interruption of work or a telephone conversation caused by the inability to maintain the operation of the computer section 130 and the portable telephone section 150. For example, when there is a sharp drop in the voltage of the battery of the portable device 100, the operation of the computer section 130 and the portable telephone section 150 cannot be maintained. Furthermore, there is no need to inhibit a telephone conversation realized by the use of the portable telephone section 150 while the computer section 130 is being booted. As a result, convenience improves. In addition, an electric power load on the battery can be reduced, so its duration can be lengthened.

If the computer section 130 is being booted and a telephone conversation is being carried out by the use of the portable telephone section 150, the method of stopping image output by the display section 101 may be adopted in order to reduce the electric power consumption of the portable device 100 further. If a liquid crystal monitor, for example, is used as the display section 101, then the electric power consumption of the display section 101 can be reduced by dimming (backlight) illumination of the monitor in the case of operation not being performed on the display section 101 for a predetermined period of time. In addition, if operation is not performed on the display section 101 for a predetermined period of time after dimming the illumination, then the display section 101 should stop image output to the monitor. This reduces electric power consumption further and is effective.

The electronic device and the system start method have been described on the basis of the embodiments shown. However, the present invention is not limited to these embodiments. The structure of each section can be replaced by an arbitrary structure having the same function. Furthermore, other arbitrary components or steps may be added to these embodiments. In addition, the structure (characteristics) of any two or more of the above-mentioned embodiments may be combined.

In the above-mentioned embodiments a CPU is shown as an example of a processing circuit. However, a processor of another type, a controller, or hardware which is equal in function to them may be used as a processing circuit.

By using the above-mentioned electronic device and system start method, electric power consumption can be reduced and convenience improves.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An electronic device powered by a battery, the device comprising:
a first information processing section;
a second information processing section operable in parallel with the first information processing section for realizing a portable telephone function;
a state check section for outputting instructions to lower a frequency of an operation clock of a processing circuit included in the first information processing section at the time of detecting that the first information processing section is being booted and that a telephone conversation is being carried out by the use of the second information processing section; and
a clock control section for lowering the frequency of the operation clock of the processing circuit at the time of accepting the instructions outputted from the state check section to lower the frequency of the operation clock of the processing circuit.

2. The electronic device according to claim 1, wherein:
when the state check section detects that a state in which the first information processing section is being booted and in which the telephone conversation is being carried out by the use of the second information processing section shifts to at least one of a state in which the first information processing section is not being booted and a state in which the telephone conversation is not being carried out by the use of the second information processing section, the state check section outputs instructions to return the frequency of the operation clock of the processing circuit; and
when the clock control section accepts the instructions outputted from the state check section to return the frequency of the operation clock of the processing circuit, the clock control section returns the frequency of the operation clock of the processing circuit to an original frequency.

3. The electronic device according to claim 1, further comprising:
a display section for displaying an image outputted from the first information processing section; and
an input section for accepting operation input provided by a user,
wherein if operation is not performed on the input section for a predetermined period of time while the first information processing section is being booted and the telephone conversation is being carried out by the use of the second information processing section, the display section performs at least one of dimming illumination of the display section and stopping displaying the image.

4. The electronic device according to claim 1, wherein the electronic device is a portable device.

5. A method for starting a system of an electronic device powered by a battery, wherein:
the electronic device includes a first information processing section and a second information processing section which is operable in parallel with the first information processing section,
when a state check section detects that the first information processing section is being booted and that a telephone conversation is being carried out by the use of the second information processing section, the state check section outputs instructions to lower a frequency of an operation clock of a processing circuit included in the first information processing section, and
when a clock control section accepts the instructions outputted from the state check section to lower the frequency of the operation clock of the processing circuit, the clock control section lowers the frequency of the operation clock of the processing circuit.
